(19) United States
(12) Patent Application Publication
(10) Pub. No.: US 2013/0301163 A1
(43) Pub. Date: Nov. 14, 2013

(54) COMPUTER COMPONENT ENCLOSURE

(71) Applicant: Jesse Kendrick, Charleston, SC (US)

(72) Inventor: Jesse Kendrick, Charleston, SC (US)

(21) Appl. No.: 13/469,013

(22) Filed: May 10, 2012

(51) Int. Cl. G11B 5/82

(52) U.S. Cl. 360/135; G9B/5.293

(57) ABSTRACT

The present invention is a computer component enclosure that includes a cube-shaped enclosed casing, a front control panel that is disposed underneath the enclosed casing, a USB power digital panel that is disposed on the front control panel and a hard drive platter that resides in the computer component enclosure. The platter reader and writer that moves above the hard drive platter, a plurality of platter holders that holds the hard drive platter that is read and written by the platter reader and writer, a power cord that provides electrical power to the computer component enclosure and downloadable recovery software that can be downloaded to the computer component enclosure to provide quick and easy access to a progress of a recovery after recovering and realigning data from the computer component enclosure.

### TECHNICAL FIELD & BACKGROUND

Computers have a hard disk platter and a circular disk on which information is reserved. When a hard drive is dismantled for repairs, it is important to keep the platters aligned to avoid losing any stored information.

The present invention generally relates to an enclosure. More specifically, the invention is a computer component enclosure.

It is an object of the invention to provide a computer component enclosure that allows a user to pull out and remove one or more bare platters from a hard drive.

It is an object of the invention to provide a computer component enclosure that realigns one or more bare platters from a hard drive to recover data that resides on the one or more bare platters.

What is really needed is a computer component enclosure that allows a user to pull out and remove one or more bare platters from a hard drive that realigns one or more bare platters from a hard drive to recover data that resides on the one or more bare platters.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a computer component enclosure, according to an embodiment of the present invention.

FIG. 1B illustrates a side view of a computer component enclosure, according to an embodiment of the present invention.

FIG. 1C illustrates a top view of a computer component enclosure, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

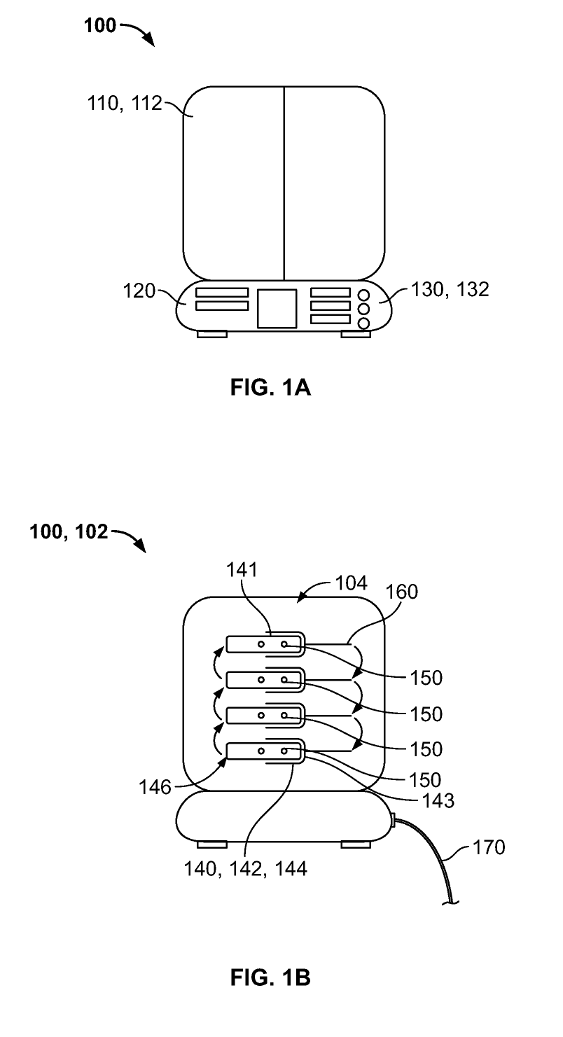

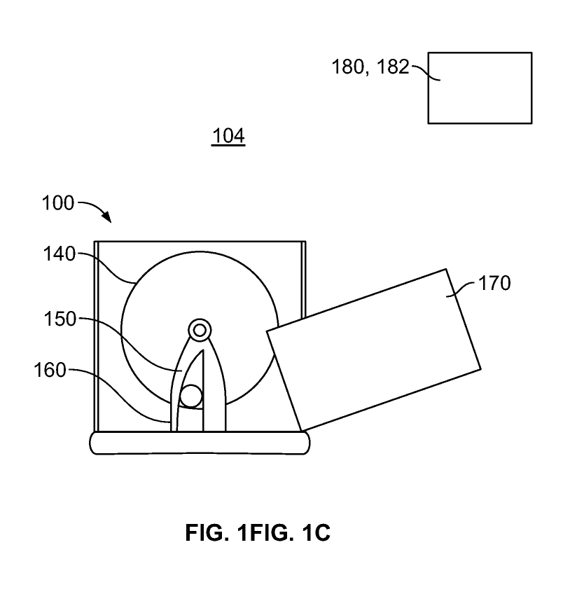

FIG. 1A illustrates a front view of a computer component enclosure 100, according to an embodiment of the present invention.

The computer component enclosure 100 includes an enclosed casing 110, a front control panel 120 and a digital panel 130. The enclosed casing 110 contains a plurality of computer components that are described and illustrated in FIG. 1B and FIG. 1C and their description. The enclosed casing 110 can be made of plastic, metal or any other suitable material. The enclosed casing 110 is cube-shaped 112 but can be any suitable shape such as rectangular-shaped. The front control panel 120 is disposed underneath the enclosed casing 110 and displays information regarding the computer component enclosure 100 and its computer components. The digital panel 130 is disposed on the front control panel 120 and is a USB power digital panel 132.

FIG. 1B illustrates a side view of a computer component enclosure 100, according to an embodiment of the present invention.

The computer component enclosure 100 illustrated in FIG. 1B is an open side view with a side 102 of the computer component enclosure 100 removed to illustrate the plurality of computer components described in FIG. 1A in an interior portion 104 of the computer component enclosure 100.

The computer component enclosure 100 includes a hard drive platter 140, a platter reader and writer 150, a plurality of platter holders 160 and a power cord 170. The hard drive platter 140 has a top portion 141 and a bottom portion 143 and resides in the interior portion 104 of the computer component enclosure 100. The hard drive platter 140 contains a plurality of magnetic information and data 142 related to a plurality of files 144 that reside on a hard drive 146 of the computer component enclosure 100. The computer component enclosure 100 can realign and recover information from up to 8 platters 140. The platter reader and writer 150 are disposed on the top portion 141 and the bottom portion 143 of the hard drive platter 140 that move above the hard drive platter 140 and transform the hard drive platter's 140 magnetic field into an electrical current that reads a hard drive 146 or transforms electrical current into a magnetic field to write the hard drive 146. The platter holders 160 hold the hard drive platter 140 to be read and written by the platter reader and writer 150. A power cord 170 provides electrical power to the computer component enclosure 100 from a hardwire electrical power source (not shown) such as an electrical outlet or other suitable hardwire electrical power source.

FIG. 1C illustrates a top view of a computer component enclosure 100, according to an embodiment of the present invention.

The computer component enclosure 100 includes a hard drive platter 140, a platter reader and writer 150, a platter holder 160, an exterior door 170 and downloadable recovery software 180. The hard drive platter 140, the platter reader and writer 150 and the platter holder 160 are similar to the hard drive platter 140, the platter reader and writer 150 and the platter holder 160 described and illustrated in FIG. 1B and its description. The exterior door 170 is openable and closable and is disposed anywhere along the enclosed casing 110 previously described in FIG. 1A. The exterior door 170 can be opened to allow access to the interior portion 104 of the enclosed casing 110 and the hard drive platter 140, the platter reader and writer 150 and the platter holder 160. The downloadable recovery software 180 can be downloaded to the computer component enclosure 100 to provide relatively quick and easy access to a progress of a recovery after recovering and realigning data from the computer component enclosure 100. One or more upgrades 182 can also be provided with the downloadable recovery software 180 to ensure that the computer component enclosure 100 can read information on relatively newer platter models as well.

The computer component enclosure maintains an alignment of a plurality of hard drive platters. The computer component enclosure can hold and realign up to 8 platters for data retrieval or storage in an alternate external hard drive system. A platter reader and writer decipher data from both a top portion and a bottom portion of the platter. Software may be downloaded to the computer component enclosure to provide relatively quick and easy access to a progress of a recovery. The computer component enclosure may be readily available at electronic stores where computer accessories are sold. The computer component enclosure features an enclosed casing which can realign and recover information from up to 8 platters from any type of suitable hard drive. The computer component enclosure is designed to download software and have upgrades to ensure that it can read information on newer platter models as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A computer component enclosure, comprising:
an enclosed casing with an interior portion;
a front control panel that is disposed underneath said enclosed casing and displays information regarding said computer component enclosure;
a digital panel that is disposed on said front control panel;
a plurality of platter holders disposed in said enclosed casing, each adapted to hold one hard drive platter in a manner which allows magnetic information and data read on and written to the hard drive platter held;
at least one hard drive platter that has a top portion and a bottom portion being held by one of said platter holders, wherein each hard drive platter contains a plurality of magnetic information and data related to a plurality of files that reside on a hard drive from which the platter was removed;
a platter reader and writer that are disposed on said top portion and said bottom portion of each said hard drive platter being held by one of said platter holders;
a power cord that provides electrical power to said computer component enclosure from a hardwire electrical power source; and
wherein the platter holders and platter reader and writer are together configured to realign and recover information from hard drive platters being held.

2. The enclosure according claim 1, wherein said enclosed casing is cube-shape.

3. The enclosure according claim 1, wherein said enclosed casing is made of metal.

4. The enclosure according claim 1, wherein said enclosed casing is made of plastic.

5. The enclosure according claim 1, wherein four platter holders are disposed in said enclosed casing.

6. The enclosure according claim 1, wherein said platter reader and writer transforms said hard drive platter's magnetic field into an electrical current that reads said hard drive.

7. The enclosure according claim 1, wherein said platter reader and writer transforms electrical current into a magnetic field to write said hard drive.

8. A computer component enclosure, comprising:
a cube-shaped enclosed casing with an interior portion;
a front control panel that is disposed underneath said enclosed casing and displays information regarding said computer component enclosure;
a digital panel that is disposed on said front control panel;
a plurality of platter holders disposed in said cube-shaped enclosed casing, each adapted to hold one hard drive platter in a manner which allows magnetic information and data read on and written to the hard drive platter held;
at least one hard drive platter that has a top portion and a bottom portion being held by one of said platter holders, wherein each hard drive platter contains a plurality of magnetic information and data related to a plurality of files that reside on a hard drive from which the platter was removed;
a platter reader and writer that are disposed on said top portion and said bottom portion of each said hard drive platter being held by one of said platter holders;
a power cord that provides electrical power to said computer component enclosure from a hardwire electrical power source; and
downloadable recovery software that is downloaded to said computer component enclosure to provide quick and easy access to a progress of a recovery after recovering and realigning data from said computer component enclosure; and
wherein the platter holders and platter reader and writer are together configured to realign and recover information from hard drive platters being held.

9. The enclosure according claim 8, wherein said enclosed casing is made of metal.

10. The enclosure according claim 8, wherein said enclosed casing is made of plastic.

11. The enclosure according claim 8, wherein said digital panel is an electrically powered digital panel.

12. The enclosure according claim 8, wherein four platter holders are disposed in said cube-shaped enclosed casing.

13. The enclosure according claim 8, wherein said platter reader and writer transforms said hard drive platter's magnetic field into an electrical current that reads said hard drive.

14. The enclosure according claim 13, wherein said platter reader and writer transforms said electrical current into a magnetic field to write said hard drive.

15. A computer component enclosure, comprising:
a cube-shaped enclosed casing with an interior portion;
a front control panel that is disposed underneath said enclosed casing and displays information regarding said computer component enclosure;
a digital panel that is disposed on said front control panel;
four platter holders disposed in said cube-shaped enclosed casing, each adapted to hold one hard drive platter in a manner which allows magnetic information and data read on and written to the hard drive platter held;
at least one hard drive platter that has a top portion and a bottom portion being held by one of said platter holders, wherein each hard drive platter contains a plurality of magnetic information and data related to a plurality of files that reside on a hard drive from which the platter was removed;
a platter reader and writer that are disposed on said top portion and said bottom portion of each said hard drive platter being held by one of said platter holders;
a power cord that provides electrical power to said computer component enclosure from a hardwire electrical power source;
downloadable recovery software that is downloaded to said computer component enclosure to provide quick and easy access to a progress of a recovery after recovering and realigning data from said computer component enclosure; and
wherein the platter holders and platter reader and writer are together configured to realign and recover information from hard drive platters being held.

16. The enclosure according claim 15, wherein said enclosed casing is made of metal.

17. The enclosure according claim 15, wherein said enclosed casing is made of plastic.

18. The enclosure according claim 15, wherein said platter reader and writer transforms said hard drive platter's magnetic field into an electrical current that reads said hard drive.

19. The enclosure according claim 18, wherein said platter reader and writer transforms said electrical current into said magnetic field to write said hard drive.

20. The enclosure according claim 15, wherein said computer component is adapted to receive and process any upgrades embedded with said downloadable recovery software.
